(19) United States
(12) Patent Application Publication
(10) Pub. No.: US 2005/0038757 A1
(43) Pub. Date: Feb. 17, 2005

(54) Memory card device, rights managing system and time managing method

(75) Inventor: Hiroyuki Wada, Minoo-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/902,822

(22) Filed: Aug. 2, 2004

(30) Foreign Application Priority Data
Aug. 11, 2003 (JP) 2003-290993

(51) Int. Cl. G06F 17/60

(52) U.S. Cl. 705/400; 705/1; 705/11

(57) ABSTRACT

A rental service handling electronic data is faced with a challenge of accurately managing time within a machine. With currently available systems, time instant data to be set could be tampered using a machine and it is therefore difficult to protect the rights over programs and data. Disposed within a memory card are a time measuring part which is capable of measuring time, a memory part in which key information and various types of data are coded and stored, a power source part which supplies power to the time measuring part and other respective parts, a code processing part which decodes time instant information set in the time measuring part and codes time instant information retrieved from the time measuring part using the key information, and a calculation control part which controls so as to validate or invalidate rights based on the various types of time instant information, whereby management of time such as the term of validity of data is always performed inside the memory card.

### BACKGROUND OF THE INVENTION

1. Field of the Invention

The present invention relates to a memory card device equipped with a coding time managing function, a rights managing system and a time managing method. To be more specific, the present invention relates to a method of recording various types of information such as a program and data and controlling validation and invalidation of rights for use of data in accordance with a condition which is associated with particular time instant information.

2. Background Art

While conventional rental services are mostly for lending commodities directly, the current environment surrounding home electric appliances where PCs (personal computers) are used in networks is now finding, unlike the conventional rental services, the increasing popularity of lending electronic data rather than commodities.

Even such a rental service, as long as it is a rental service, necessitates restriction of rights for use of electronic data within the framework of management which is based on particular time instant information. In other words, management of time instant information is one of the most important elements of a rental service. One way of managing time is use of time instant information of a host machine. However, a user can presently often set time instant information of a host machine. This has led to a problem that a user can thus easily correct time instant information of a host machine and extend the time limit and it is not therefore easy to protect copyrights.

Invalidation has been proposed as a solution, e.g., to dispose a timer within an IC card, the timer starts measuring time upon lending of a dated content, and the content is deleted when the time limit has come. (See Japanese Patent Application Laid-Open Gazette No. S63-204495, Japanese Patent Application No. S62-35785.)

Although the patent application document mentioned above is effective in solving the problems with the conventional techniques since it is not necessary to manage time in a host machine according to this the patent application document, management of time instant information per se assumes that a machine in which term-of-validity information is set is trustworthy and therefore allows that time limit setting data are out on a channel between a host machine and an IC card during setting up of the term-of-validity information in a memory card. In short, a tampered host machine or tampering of data on a communication bus if any permits setting up of unauthorized effective term-of-validity information on the card. This in turn gives rise to a problem that a rental content can be used indefinitely and copyright protection thus fails.

As described above, an electronic data rental service is confronted with a challenge of accurately managing time in a machine. In the current system, there is a risk that time data to be set could be tampered using a machine and it is therefore difficult to protect rights over programs and data.

Further, it is merely one term of validity that can be managed in a card, since a timer starts measuring time upon registration of the term of validity. Hence, for the purpose of simultaneously managing the terms of validity of a plurality of contents, as many timers as the terms of validity to be managed are needed, which is a problem in terms of H/W (hardware) resource.

### SUMMARY OF THE INVENTION

An object of the present invention is to provide a memory card device, a rights managing system and a time managing method with which it is possible to prevent unauthorized modification of data and simultaneously manage the terms of validity of a plurality of contents without installing as many timers as the terms of validity to be managed.

A memory card device according to the present invention comprises: a power source part which is capable of supplying power; a time measuring part which is provided with electric power from the power source part and measures time instant information; a memory part which stores coded data which is fed to the memory part; a code processing part which decodes the coded data which has been stored in the memory part and/or codes the time instant information which is measured by the time measuring part; and a calculation control part which controls so as to validate or invalidate the coded data which has been stored in the memory part while referring at least to the time instant information which is measured by the time measuring part. The code processing part performs at least one of decoding of encoded data which has been stored in the memory part and coding of time instant information measured by the time measuring part.

In this structure, the coded time instant information is set in the memory card from outside, the code processing part decodes the coded time instant information stored in the memory part inside the memory card, the current time is set in the time measuring part, and the time measuring part of the memory card, provided with electric power from the power source part, always measures the current time, and hence, it is possible to manage the time instant information inside the memory card.

With the time measuring part, the code processing part and the power source part disposed thus inside the memory card, coded time information is sent to and received from a server and the time information is managed merely by the memory card without using electric power or the time information of the host machine. Hence, the security of data is guaranteed even on a channel leading to the server, and since the term of validity and the effective date of data can be managed using the information contained within the memory card even despite unauthorized modification of time instant information of the host machine, the security of data is guaranteed in a highly reliable manner.

In the structure above, a timer which counts relative time from a start point is disposed as the time measuring part, set with term-of-validity information which serves as time information and has been decoded by the code processing part after received as it was coded from an external host machine, the timer counts the term-of-validity information, and the calculation control part controls so as to validate or invalidate the coded data while referring the term-of-validity information counted by the timer.

In the structure above, a real time clock which measures absolute time is disposed as the time measuring part, date information which serves as time information and was received as it was coded from an external host machine is stored in the memory part, and the calculation control part compares the date information which has been decoded by the code processing part with absolute time measured by the real time clock and controls so as to validate or invalidate the coded data in accordance with the result of the comparison.

The structure above as it is when the time measuring part is a real time clock needs only one clock for management of a plurality pieces of data, thereby reducing the hardware resource.

A rights managing system according to the present invention comprises the memory card device above, a host machine and a management server, wherein the management server and the memory card device have a common secret key, and time information is sent from the management server to the memory card device via the host machine and coded using the secret key.

In the structure above, the code processing part inside the memory card is equipped with secret key coding processing, time instant information coded within the management server using the secret key which is common to the memory card is set in the memory card via the host machine which is connected with the server on a certain channel, the time instant information is decoded using the secret key which is internally held and set in the time measuring part, and hence, it is possible for the management server on a network to code and manage the time instant information and maintain the security within a machine without any necessity of managing the time instant information written in a plain language within the host machine which is compatible with the memory card.

A different rights managing system according to the present invention comprises the memory card device above, a host machine and a management server and allowing key exchange by means of coding of a secret key using a public key, wherein the management server codes a signature which proves the validity using the public key, codes time information using a secret key and sends the same to the memory card device via the host machine, and the memory card decodes the signature using the public key which is held inside the memory card, and after confirming the validity of the signature, using the secret key, decodes the time information sent from the management server to the memory card device via the host machine.

In the structure above, as the public key is coded, it is possible to safely share the secret key and omit setting of the time measuring part within the memory card other than from a reliable management server.

Yet different rights managing system according to the present invention comprises the memory card device above, a host machine and a management server, wherein coded data is data whose term of validity needs be set and has been coded using a first secret key, time information is coded using a second secret key which is different from the first secret key, and counting of the term of validity starts as the code processing part of the memory card device decodes the time information and sets the same as the term of validity to the timer, and when the term of validity is passed, the timer outputs an interrupt signal to the calculation control part and the first secret key which is for decoding the coded data is deleted from the memory part of the memory card device.

By means of the structure above, the security of data is guaranteed even on a channel with the server, and since the term of validity and the effective date of data can be managed using the information contained within the memory card even despite unauthorized modification of time instant information of the host machine, the security of data is guaranteed in a highly reliable manner.

In the structure above, at the time that the code processing part decodes time information and sets the same to a timer part, an interrupt signal is outputted to the calculation control part upon first decoding of coded data executed by the code processing part, and the timer part starts counting the term of validity in response to an instruction fed from the calculation control part.

The structure above permits setting of a term of validity based on the time of actual use by a user.

Other rights managing system according to the present invention comprises the memory card device above, a host machine and a management server, wherein coded data is data whose effective date needs be set and has been coded using a first secret key, time information is coded using a second secret key which is different from the first secret key, the real time clock, set with an initial value in absolute time upon shipment from a factory or during communication with the management server, measures absolute time, and when the coded data is to be used, the time information is decoded and compared with absolute time measured by the real time clock and whether it is the effective date or not is determined, and the first secret key is made valid when it is the effective date but made invalid when it is not the effective date, thereby managing effective dates.

In the structure above, the time measuring part inside the memory card comprises the real time clock (RTC) for the purpose of managing right-related time instant information, the current date has been set in advance within the memory card upon shipment from a factory, the current date is always measured inside the memory card, the code processing part decodes coded right-related time instant information which has been set from outside and the calculation control part compares this with the current time, whereby the secret key for decoding coded data is validated or invalidated under control, the right over data beyond the term of validity is protected and right-related time instants on a plurality pieces of data are managed at the same time.

In the memory card device above, a real time clock which measures absolute time is disposed as the time measuring part, and the code processing part codes current date information inside the real time clock as it is upon occurrence of an access from the host machine to particular data which is within the memory card, and stores as coded time-of-use information in the memory part.

The structure above permits management of access time to data and eliminates a risk of tampering of the time-of-use information. Further, this is realized by the memory card alone, without requiring an access to an external server. Use of the public key for coding of current date information allows only an external management machine which has the secret key corresponding to the public key to decode the time-of-use information, and therefore, it is possible to safely manage the time-of-use information.

A time managing method according to the present invention is a time managing method comprising a management server, a host machine and a memory card which uses a system which comprises a code processing part, a timer part and a calculation control part, the method comprising the steps of: coding term-of-validity-of-right information within the management server using a secret key and creating coded term-of-validity-of-right information; transferring the coded term-of-validity-of-right information to the host machine; setting the coded term-of-validity-of-right information to the memory card; making the code processing part which is inside the memory card decode the coded term-of-validity-of-right information; setting thus decoded term-of-validity-of-right information to the timer part and causing a timer to count, and upon arrival of the count at a term of validity, generating a timer interruption; causing the calculation control part to validate a data decode key in the absence of the timer interruption; and causing the calculation control part to delete said data decode key in the presence of the timer interruption.

Another time managing method according to the present invention is a time managing method comprising a management server, a host machine and a memory card which uses a system which comprises a code processing part, a real time clock and a calculation control part, the method comprising the steps of: coding time instant information and granted-days information within the management server using a secret key and creating coded time instant information and coded granted-days information; transferring the coded time instant information and the coded granted-days information to the host machine; setting the coded time instant information and the coded granted-days information to the memory card; making the code processing part which is inside the memory card decode the coded time instant information and the coded granted-days information; setting thus decoded time instant information to the real time clock and always counting the current time; causing the calculation control part to validate a data decode key when a right is found valid from the current time and the granted-days information; and causing the calculation control part to invalidate said data decode key when the right is found invalid from the current time and the granted-days information.

Yet another time managing method according to the present invention is a time managing method using a memory card which comprises a real time clock, a code processing part and a memory part and within which the current time is set, the method comprising the steps of: acquiring current time information from the real time clock which is inside the memory card upon occurrence of an event to the memory card from outside; making the code processing part which is inside the memory card execute coding of thus acquired time instant information; and saving thus coded time instant information in the memory part which is inside the memory card.

In the structure above, current time information as it is upon occurrence of an event is acquired from the real time clock, coded and saved inside the memory card, and hence, the time at which a particular event has occurred can be maintained while preventing tampering, which allows an application to a time card or the like.

### BRIEF DESCRIPTION OF THE DRAWINGS

FIG. 1 is a block diagram of a first preferred embodiment of the present invention, wherein variable data information such as time and a key is circled;

FIG. 2 is a block diagram for describing how to use a memory card, wherein variable data information such as time and a key is circled;

FIG. 3 is a block diagram of a rights managing system, wherein variable data information such as time and a key is circled;

FIG. 4 is a flow chart of a time managing method;

FIG. 5 is a block diagram of a rights managing system according to a second preferred embodiment, wherein variable data information such as time and a key is circled;

FIG. 6 is a flow chart of a time managing method according to the second preferred embodiment;

FIG. 7 is a block diagram of a rights managing system according to a third preferred embodiment, wherein variable data information such as time and a key is circled; and

FIG. 8 is a flow chart of a time managing method according to the third preferred embodiment.

### DETAILED DESCRIPTION OF THE PREFERRED EMBODIMENTS

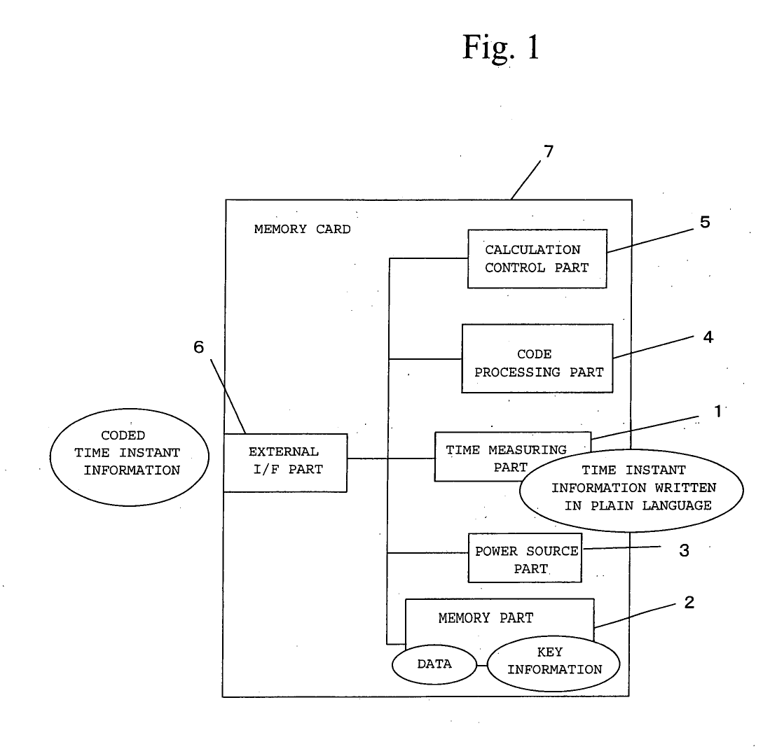

A first preferred embodiment of the present invention will now be described with reference to FIGS. 1 through 4. FIG. 1 is a drawing which shows a basic structure of a memory card according to the present invention. The memory card according to the present invention internally comprises a time measuring part 1 which is capable of measuring time, a memory part 2 which codes and stores key information and various types of data, a power source part 3 feeding power to the time measuring part 1 and other respective parts, a code processing part 4 which decodes time instant information set in the time measuring part 1 and codes time instant information retrieved out from the time measuring part 1 using the key information mentioned above, a calculation control part 5 which controls validation and invalidation of rights based on various types of time instant information, and an external I/F (interface) part which communicates with a host machine.

In the case of the memory card according to the present invention, using the time measuring part 1 fed with power from the power source part 3, the memory card alone can measure time. Further, with acquisition of coded time information from outside, it is possible to decode internally. Hence, storing thus acquired time information from outside in the memory part 2, decoding the same in the code processing part 4 and using the same, the memory card can manage terms of validity on the stand alone basis.

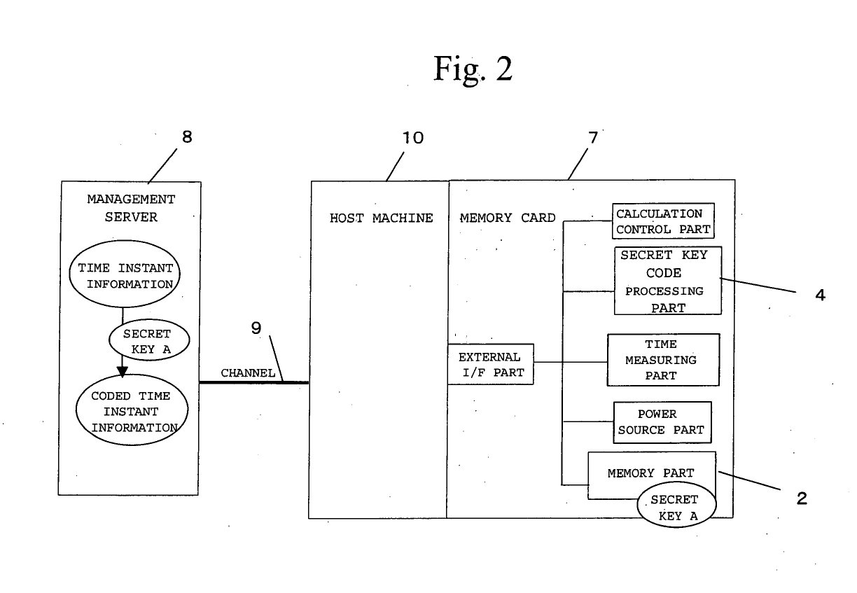

FIG. 2 is a basic structure diagram for describing how to use the memory card according to the present invention. As shown in the block diagram in FIG. 2, via a host machine 10 which is connected with a management server 8 on a certain channel 9, the memory card 7 of the present invention acquires time information which has been coded within the management server 8 using a secret key which common to the memory card 7, and decodes the time information using the secret key which is held within the memory card 7. Thus, the management server 8 on the network codes the time information using the secret key and manages the time information and the memory card 7 internally decodes the time information and uses the time information, thereby eliminating the necessity of managing the time information written in a plain language within the host machine 10 which is compatible with the memory card, and in addition, since the time information as it is coded is transmitted also on the channel 9, security within the machine is ensured.

Time information to be coded within the management server 8 using the secret key which common to the memory card 7 may be term-of-validity-of-right information in relative time expressing the term of validity from a certain time point, or granted-days information in absolute time expressing a certain date, or alternatively, time instant information expressing the current time itself, which will be described in detail later. In addition, while a secret key coding method maybe such a coding method as DES, T-DES, AES and C2, any coding algorithm of the same type may be used of course.

Further, public key coding processing may be added to the secret key coding processing in the coding processing part described above. To be more specific, the secret key itself is coded using a public key as key exchange, the management server 8 codes a signature which proves the validity using the public key and codes time information using the secret key which will then be set inside the memory card 7 via the host machine 10 which is connected with the management server 8 on the certain channel 9, the signature is decoded using the public key which is held inside, and after confirmation of the validity of the signature from the management server 8, the time information is decoded using the secret key. The public key coding processing described above makes it possible to safely share the secret key and eliminate settings of the time measuring part 1 which is inside the memory card 7 other than from the reliable management server 8. While a public key decoding method may be RSA, an elliptic curve cryptography or the like, any coding algorithm of the same type may be used of course.

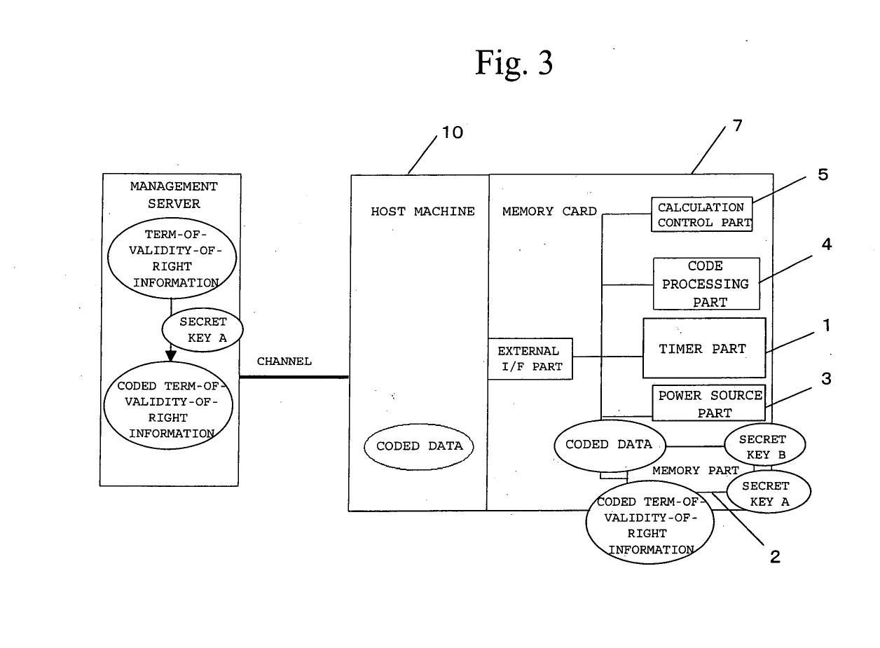

The first preferred embodiment of the present invention will now be described in detail. FIG. 3 is a block diagram which shows the first preferred embodiment of the present invention. In the first preferred embodiment of the present invention, data for whose term of validity needs be set is coded using a certain secret key and stored in the memory part 2 of the memory card 7 or the host machine 10 from any desired place. In addition, the secret key which is used for decoding of data is stored within the memory part 2 of the memory card 7. Term-of-validity-of-right information indicative of the term of validity is coded using other secret key and stored within the memory part 2, decoded in the code processing part 4 within the memory card 7 and set in the time measuring part (timer part) 1. Once set with the term-of-validity-of-right information, the timer part 1 starts measuring the term. For instance, when the term of validity becomes 0, the timer part 1 outputs an interrupt signal to the calculation control part 5, the secret key for decoding the coded data is deleted from the memory part 2, and the right to use the data is erased. This permits coding and setting of term-of-validity-of-right information and invalidation of the right to use the data after the term of validity is passed.

It is needless to mention that two types of secret keys may be made the same key, and further that the host machine 10 may be different machines between setting of term-of-validity-of-right information and use of the data.

Further, the system above is usable even in an instance that an external host machine 10 or the like also manages coded data itself instead of managing the coded data only within the memory card 7 and only time management of a decode key is performed within the memory card 7, of course.

In addition, in such a situation described above, instead of start measuring the term at the time that the code processing part 4 decodes and sets coded term-of-validity-of-right information to the timer part 1, the interrupt signal may be outputted to the calculation control part 5 upon first decoding of coded data within the code processing part 4 and the timer part 1 may start measuring time in response to an instruction fed from the calculation control part 5. This permits setting of a term of validity based on the time of actual use by a user.

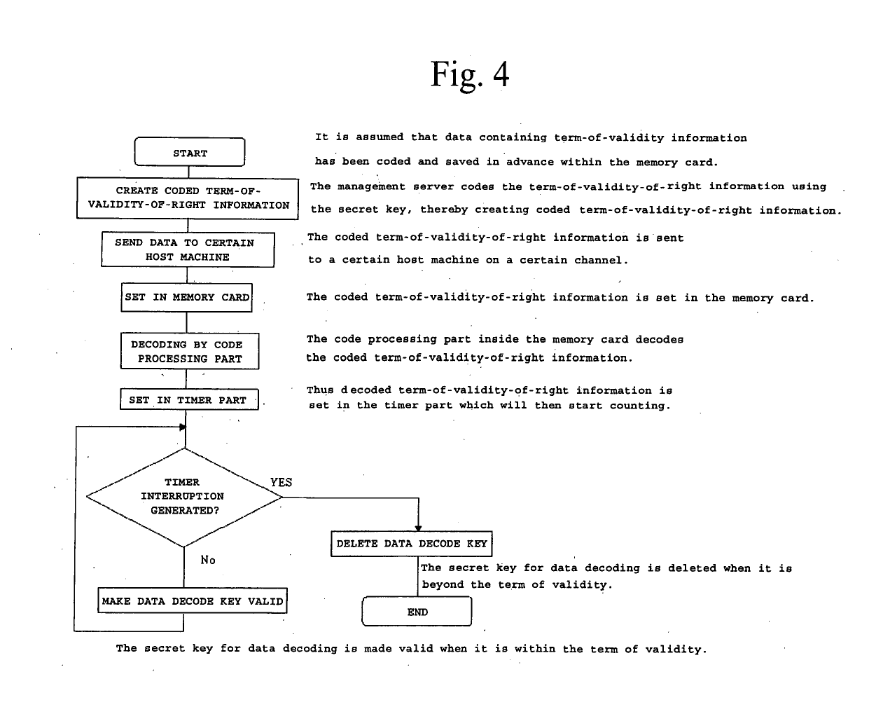

A term of validity managing method according to the first preferred embodiment of the present invention will now be described with reference to the flow chart in FIG. 4. Although not described as for the flow chart in FIG. 4 on the assumption that dated data and a secret key for decoding the data are coded and saved in advance within the memory card 7, the memory card 7 may acquire the data and the secret key for decoding the data in any desired way. The acquisition may be concurrent with acquisition of coded term-of-validity-of-right information which will be described later.

First, the management server 8 codes term-of-validity-of-right information using a secret key, thereby creating coded term-of-validity-of-right information. The coded term-of-validity-of-right information thus created is then sent to a host machine 10 which uses data via a certain channel. The memory card 7 stores within the memory part 2 the coded term-of-validity-of-right information thus sent to the host machine 10, and the code processing part 4 decodes and sets the term-of-validity-of-right information to the timer part 1. Set with the decoded term-of-validity-of-right information, the timer part 1 starts counting. When the count has reached a term of validity, the calculation control part 5 is fed with the interrupt signal and the key for data decoding is deleted. Hence, the data can not be decoded after the term of validity has been passed.

For example, the present invention is applicable to a content rental service described below.

(1) At the time of shipment of the memory card 7 from a factory, a secret key for public key unique to the card is set in a protected memory area of the memory card 7 which denies an access from outside the memory card 7. A public key is stored in a normal memory area.

(2) In a rental server such as that installed for a rental shop on a network, during member registration, one reads out the public key of the memory card 7 one uses from within the memory area of the memory card and registers the public key.

(3) The rental server codes, using the public key, a secret key which is used for coding of a content, codes a content desired by a user and content-rental-days information using this secret key and sends these to a user's replay machine via a network.

(4) The user's replay machine performs mutual authentication for confirmation of the validity of the memory card 7 relative to the machine, and sets the coded secret key, the coded content and the coded content-rental-days information within a memory area.

(5) Inside the memory card 7, the coded secret key thus acquired is decoded using the secret key for public key and stored in a protected memory area of the memory card 7 which denies an access from outside.

(6) The content-rental-days information is decoded based on the secret key which is made available as described under (5), time expressing the rental days is set within the timer part 1 of the memory card 7, and the timer starts operating.

(7) When the timer finds that the term of the rental days has just passed, the calculation control part 5 is interrupted and the secret key for decoding the content is deleted.

(8) Although the user can decode content as usual during the term of validity while using the content, when it is beyond the term of validity, the deletion of the decode key described under (7) makes it impossible to use the content.

(9) It is thus possible to invalidate the right to use the content automatically when the content rental days have elapsed and accordingly force the content rental days, i.e., secure the limitation upon use of the content.

In this manner, it is possible to securely set coded time instant information which is externally provided as time instant information inside the memory card 7, and as the term of validity and granted days of a program and data are managed inside the memory card 7 and a decode key is invalidated upon invalidation of the right, the right over a program and data is protected in particular time units.

It is needless to mention that in the system above, the memory card alone can manage the right to rent a content since the content rental days and the rental time are set in the timer and a decode key is automatically deleted when the rental period ends. This system may be of course applied in such a manner that without storing a content itself within the memory card 7, a decode key alone is lent only for a certain period to thereby decode and use an external content.

As a further additional service, it is possible to provide a fee refund function for early return of a content within a rental period, and it is easy to offer a content shopping service for providing a permanent right to use the content after rental.

These are merely examples and the present invention is of course applicable to any system which invalidates a right based on some term-of-validity information.

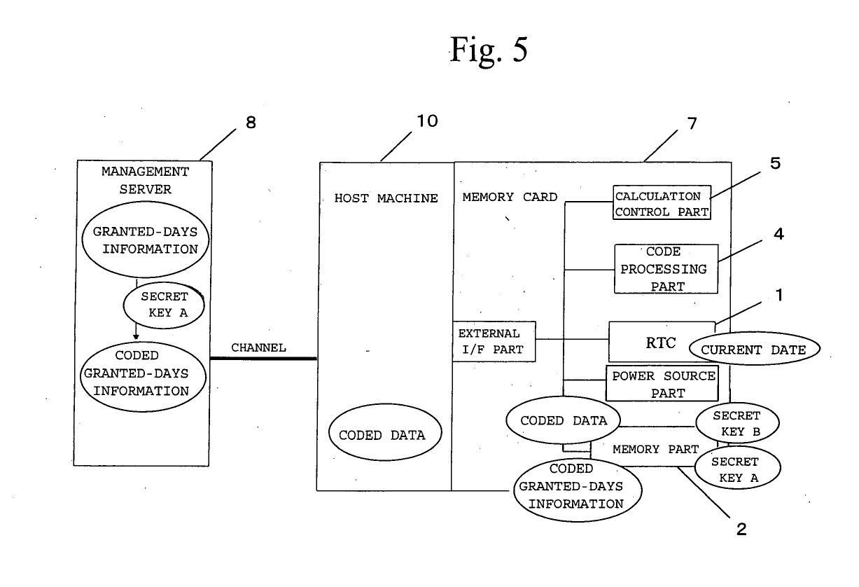

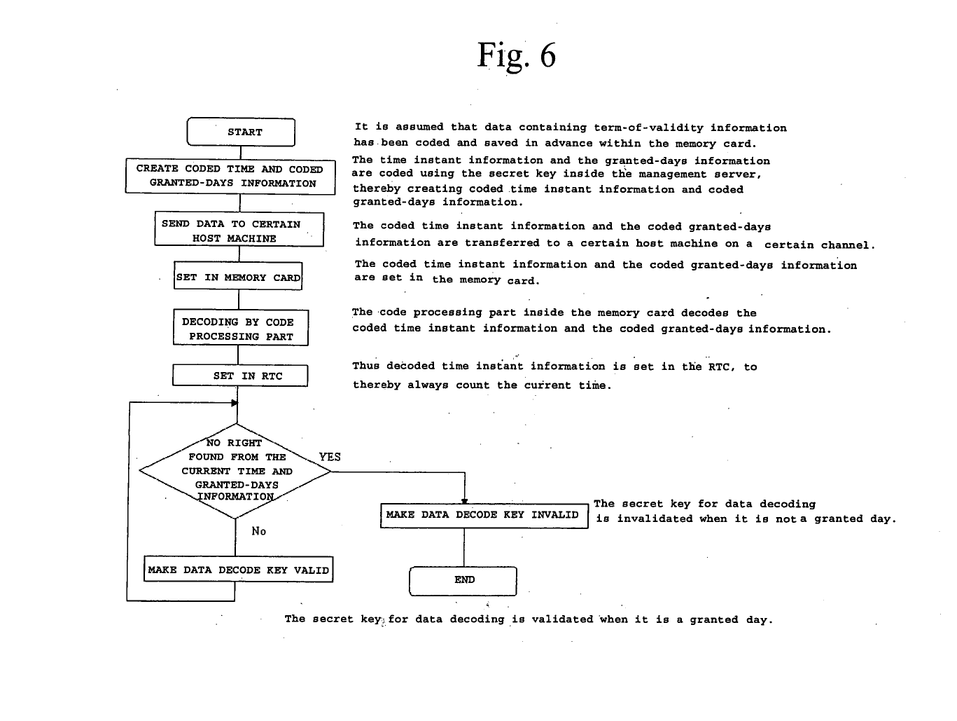

A second preferred embodiment of the present invention will now be described with reference to FIGS. 5 and 6. FIG. 5 is a block diagram which shows the second preferred embodiment of the present invention. Unlike the first preferred embodiment, the second preferred embodiment demands that the time measuring part 1 is formed by a real time clock (RTC) instead of a timer. As the real time clock communicates with the management server 8, time instant information is set to in absolute time within the real time clock. The time instant information is sent as it is coded from the management server 8, decoded within the memory card 7, and set in the real time clock. Once thus set, the real time clock always measures the current time within the memory card 7. The real time clock may be configured such that the current date is set upon shipment from a factory.

The memory card 7 according to the second preferred embodiment of the present invention acquires coded granted-days information from the management server 8 in addition to coded time instant information, and an ordinary user of the memory part 2 stores the same in an inaccessible area. The granted-days information describes, in absolute time, the time limit for accessing data and days on which accessing to the data are granted. When one attempts to use data which is usable during a certain term of validity and up until a certain date, the calculation control part 5 decodes the coded granted-days information and compares the same with the current time measured by the real time clock. A secret key for decoding coded data is validated or invalidated under control in accordance with the result of the comparison, thereby protecting the right over the data. This permits providing a rights service based on particular date and hour.

Further, since the right-related time instant information is managed in absolute time in the second preferred embodiment, even though there is only one real time clock, time management for a plurality pieces of data is realized while referring to a plurality pieces of granted-days information corresponding to the respective pieces of data.

A method of managing an effective date according to the second preferred embodiment of the present invention will now be described with reference to the flow chart in FIG. 6. Although not described as for the flow chart in FIG. 6 on the assumption that data bearing an effective date and a secret key for decoding the data are coded and saved in advance within the memory card 7, the memory card 7 may acquire the data and the secret key for decoding the data in any desired way. The acquisition may be concurrent with acquisition of coded granted-days information which will be described later.

First, the management server 8 codes time instant information and granted-days information in absolute time using a secret key, thereby creating coded time instant information and coded granted-days information. The coded time instant information and the coded granted-days information thus created are then sent to a host machine 10 which uses data via a certain channel. The memory card 7 stores within its memory the coded time instant information and coded granted-days information thus sent to the host machine 10, and the code processing part 4 decodes and sets these, and the real time clock is set.

Following this, the coded granted-days information is stored in an area which is inaccessible for a user of the memory part 2. When one tries to use data which is usable until a certain time limit and on certain days, the coded granted-days information is decoded and compared with the date set within the real time clock. When it is still such a day that use of the data is allowed, a data decode key is validated and the data is decoded. When it is such a day that the data is not usable, the data decode key is invalidated. The data can thus be decoded only on particular dates and at particular instants.

For example, the present invention is applicable to a content rental service described below.

(1) At the time of shipment of the memory card 7 from a factory, the current date is set in the RTC part 1 of the memory card 7, and a secret key for public key unique to the card is set in a protected memory area of the memory card 7 which denies an access from outside the memory card 7. A public key is stored in a normal memory area.

(2) In a rental server such as that installed for a rental shop on a network, during member registration, one reads out the public key of the memory card 7 one uses from within the memory area of the memory card and registers the public key.

(3) The rental server codes, using the public key, a secret key which is used for coding of a content, codes a content desired by a user and content return date information using this secret key and sends these to a user's replay machine via a network.

(4) The user's replay machine performs mutual authentication for confirmation of the validity of the memory card 7 relative to the machine, and sets the coded secret key, the coded content and the coded content return date information within a memory area.

(5) Inside the memory card 7, the coded secret key thus acquired is decoded using the secret key for public key and stored in a protected memory area of the memory card 7 which denies an access from outside.

(6) The coded content return date information is read out from the memory and decoded upon when the memory card 7 receives a content replay request from the user, the current date is read out from the RTC part 1, and when the content return date information is later than the current date, the calculation control part 5 decodes the content.

(7) When the content return date information is found at (6) to be earlier than the current date, the calculation control part 5 is controlled so as not to decode the content.

(8) (7) above makes it impossible to decode the coded content, thereby making the content unavailable. In other words, the right for the content is automatically invalidated after the content return date, and the content return date, namely, the limitation for use of the content is ensured.

It is needless to mention that in the system above, since the content return date is coded and managed in the memory part 2 and read out at the time of decoding of the content, it is easy to manage the return dates of a plurality of contents in the memory part 2. This system may be of course applied in such a manner that without lending a content itself, a decode key alone is lent for a certain period.

As a further additional service, it is possible to provide a fee refund function for early return of a content within a rental period, and it is easy to offer a content shopping service for providing a permanent right to use the content after rental. While the above is an example of a content rental service, it is possible to extend a service which allows use of a content since a particular date, e.g., makes a content available on such a day that magazines or the like are put on sale, or it is possible to extend an accurate time instant service in time units.

These are merely examples and the present invention is of course applicable to any system which invalidates a right based on some term-of-validity information.

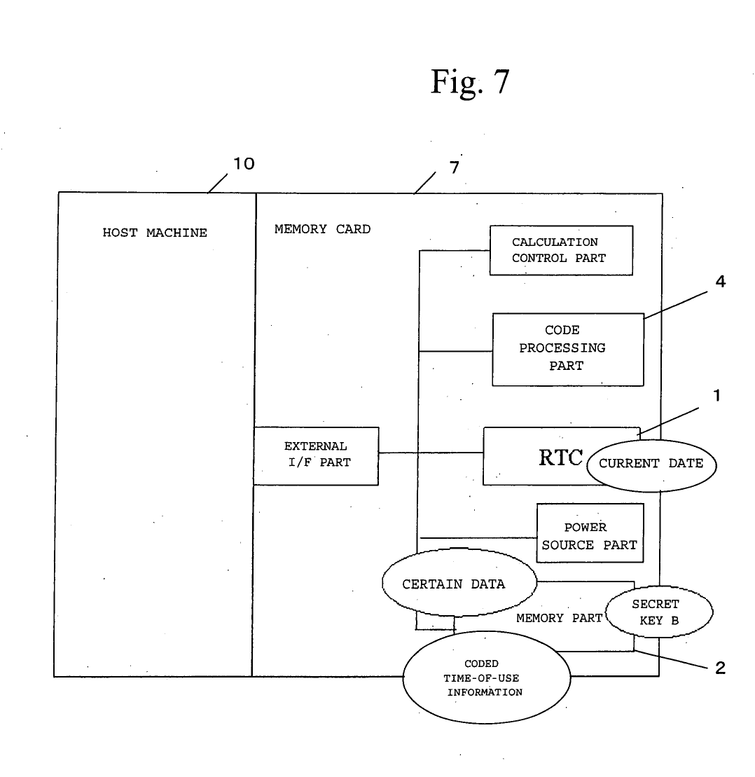

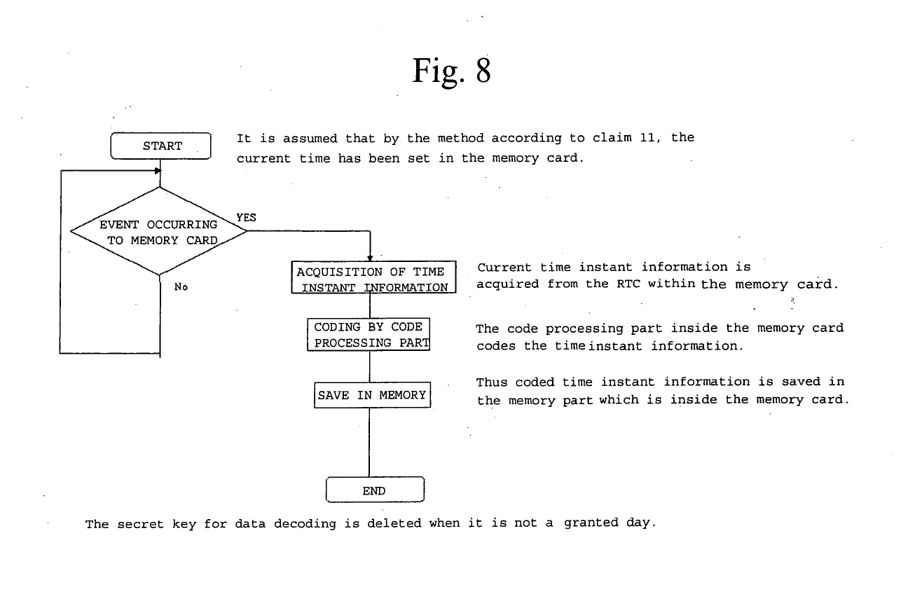

A third preferred embodiment of the present invention will now be described with reference to FIGS. 7 and 8. FIG. 7 is a block diagram which shows the third preferred embodiment of the present invention. As in the second preferred embodiment, the time measuring part 1 is formed by a real time clock (RTC) in the third preferred embodiment. Time instant information is set in the real time clock in absolute time at the time of shipment from a factory. Once thus set, the real time clock always measures the current time within the memory card.

In the third preferred embodiment, as a host machine 10 accesses to particular data which is within the memory card 7, the code processing part 4 codes current date information which is within the RTC part 1 using a code key of some external management machine, e.g., a secret key which is common to the external management machine or using a public key and stores this as coded time-of-use information in the memory part. This permits data access time management and eliminates a risk of tampering of the time-of-use information. This system does not need an access to an external server like the one described earlier, and can be realized only with the memory card. Use of a public key for coding of current date information allows only the external management machine which has a secret key corresponding to the public key to decode the time-of-use information, whereby the time-of-use information is managed safely.

A method of managing an effective date according to the third preferred embodiment of the present invention will now be described with reference to the flow chart in FIG. 8. In the flow chart in FIG. 8, the current time has been already set to the real time clock at the time of shipment from a factory.

As a certain event arises outside the memory card, current time information is acquired from the real time clock. The code processing part 4 decodes thus coded time instant information using a code key of a certain external terminal. The coded time instant information is then stored in the memory part within the memory card 7.

A specific example of application is management of a service-hours time card and the number of time a content is used. The following is procedures on an example of a service-hours time card.

(1) Assuming that a dedicated terminal and the current time have been already set in the RTC parts 1 of the memory cards 7 at the time of shipment from a factory, a public key of a manager is set in the memory parts 2 of the memory cards 7.

(2) The memory cards 7 are given one each to each worker whose service hours needs be managed, and the workers make simple entries on the memory cards 7 via the dedicated terminal and ordinary machines before and after their services.

(3) At this stage, inside the memory cards 7, based on events such as the insertion of the cards and data accesses, the code processing parts 4 code current time information set in the RTCs using the public key of the manager, and store the time instant information in the memory parts 2.

As a result, it is impossible for the workers to modify or tamper the time instant information, and only the manager whose has a secret key can decode and retrieve the time instant information. In short, the manager can accurately grasp from the memory cards 7 how the workers are serving.

An example of the number of time a content is used is based on the content rental service which the precedent embodiments relate to, and procedures for the same are as described below.

(1) Assuming that a dedicated terminal and the current time have been already set to the RTC parts 1 of the memory cards 7 at the time of shipment from a factory, a public key of a manager of a rental shop is set in the memory parts 2 of the memory cards 7.

(2) In the content rental service which the precedent embodiments relate to, contents have been already lent out or otherwise serviced and information regarding the contents has been stored in the memory cards 7.

(3) During replay of the contents, based on events which are decoding of contents, the code processing parts 4 code current time information set in the RTC parts 1 using the public key of the manager of the rental shop, and store the time instant information in the memory parts 2.

The manager of the rental shop can thus grasp in which time zones users watched the contents and how many times the users watched the contents and therefore can charge fees which correspond to the number of times the contents were watched. As an advantage to the users, those users who did not watch at all will not be charged and the users will be charged only in accordance with the number of times the users used the contents and how long the users used the contents.

It is needless to mention that information regarding accesses (users, the dates of use, the duration of use) to important information within the memory card 7 or the like can be managed based on a log.

These are merely examples and the present invention is of course applicable to any system which codes current time information upon occurrence of a certain event using a code key and accordingly manages the current time information.

1. A memory card device, comprising:
a power source part which is capable of supplying power;
a time measuring part which is provided with electric power from said power source part and measures time instant information;
a memory part which stores coded data which is fed to said memory part;
a code processing part which decodes said coded data which has been stored in said memory part and/or codes said time instant information which is measured by said time measuring part; and
a calculation control part which controls so as to validate or invalidate said coded data which has been stored in said memory part while referring at least to said time instant information which is measured by said time measuring part.

2. The memory card device of claim 1, wherein a timer which counts relative time from a start point is disposed as said time measuring part,
set with term-of-validity information which serves as time information and has been decoded by said code processing part after received as it was coded from an external host machine, said timer counts said term-of-validity information, and
said calculation control part controls so as to validate or invalidate said coded data while referring said term-of-validity information counted by said timer.

3. The memory card device of claim 1, wherein a real time clock which measures absolute time is disposed as said time measuring part,
date information which serves as time information and was received as it was coded from an external host machine is stored in said memory part, and
said calculation control part compares said date information which has been decoded by said code processing part with absolute time measured by said real time clock and controls so as to validate or invalidate said coded data in accordance with the result of the comparison.

4. A rights managing system comprising the memory card device of claim 2 or 3, a host machine and a management server, wherein
said management server and said memory card device have a common secret key, and time information is sent from said management server to said memory card device via said host machine and coded using said secret key.

5. A rights managing system comprising the memory card device of claim 2 or 3, a host machine and a management server and allowing key exchange by means of coding of a secret key using a public key, wherein
said management server codes a signature which proves the validity using said public key, codes time information using a secret key and sends the same to said memory card device via said host machine, and
said memory card decodes said signature using said public key which is held inside said memory card, and after confirming the validity of said signature, using said secret key, decodes said time information sent from said management server to said memory card device via said host machine.

6. A rights managing system comprising the memory card device of claim 2, a host machine and a management server, wherein
coded data is data whose term of validity needs be set and has been coded using a first secret key,
time information is coded using a second secret key which is different from said first secret key, and
counting of said term of validity starts as said code processing part of said memory card device decodes said time information and sets the same as the term of validity to said timer, and when the term of validity is passed, said timer outputs an interrupt signal to said calculation control part and said first secret key which is for decoding said coded data is deleted from said memory part of said memory card device.

7. The rights managing system of claim 6, wherein at the time that said code processing part decodes time information and sets the same to a timer part, an interrupt signal is outputted to said calculation control part upon first decoding of coded data executed by said code processing part, and said timer part starts counting the term of validity in response to an instruction fed from said calculation control part.

8. A rights managing system comprising the memory card device of claim 3, a host machine and a management server, wherein
coded data is data whose effective date needs be set and has been coded using a first secret key,
time information is coded using a second secret key which is different from said first secret key,
said real time clock, set with an initial value in absolute time upon shipment from a factory or during communication with said management server, measures absolute time, and
when said coded data is to be used, said time information is decoded and compared with absolute time measured by said real time clock and whether it is said effective date or not is determined, and said first secret key is made valid when it is said effective date but made invalid when it is not said effective date, thereby managing effective dates.

9. The memory card device of claim 1, wherein a real time clock which measures absolute time is disposed as said time measuring part, and said code processing part codes current date information inside said real time clock as it is upon occurrence of an access from said host machine to particular data which is within said memory card, and stores as coded time-of-use information in said memory part.

10. A time managing method comprising a management server, a host machine and a memory card which uses a system which comprises a code processing part, a timer part and a calculation control part,
said method comprising the steps of:
coding term-of-validity-of-right information within said management server using a secret key and creating coded term-of-validity-of-right information;
transferring said coded term-of-validity-of-right information to said host machine;
setting said coded term-of-validity-of-right information to said memory card;
making said code processing part which is inside said memory card decode said coded term-of-validity-of-right information;
setting thus decoded term-of-validity-of-right information to said timer part and causing a timer to count, and upon arrival of the count at a term of validity, generating a timer interruption;
causing said calculation control part to validate a data decode key in the absence of said timer interruption; and
causing said calculation control part to delete said data decode key in the presence of said timer interruption.

11. A time managing method comprising a management server, a host machine and a memory card which uses a system which comprises a code processing part, a real time clock and a calculation control part,
said method comprising the steps of:
coding time instant information and granted-days information within said management server using a secret key and creating coded time instant information and coded granted-days information;
transferring said coded time instant information and said coded granted-days information to said host machine;
setting said coded time instant information and said coded granted-days information to said memory card;
making said code processing part which is inside said memory card decode said coded time instant information and said coded granted-days information;
setting thus decoded time instant information to said real time clock and always counting the current time;
causing said calculation control part to validate a data decode key when a right is found valid from the current time and said granted-days information; and
causing said calculation control part to invalidate said data decode key when the right is found invalid from the current time and said granted-days information.

12. A time managing method using a memory card which comprises a real time clock, a code processing part and a memory part and within which the current time is set,
said method comprising the steps of:
acquiring current time information from said real time clock which is inside said memory card upon occurrence of an event to said memory card from outside;
making said code processing part which is inside said memory card execute coding of thus acquired time instant information; and
saving thus coded time instant information in said memory part which is inside said memory card.
